(19) United States
(12) Patent Application Publication
(10) Pub. No.: US 2014/0137391 A1
(43) Pub. Date: May 22, 2014

(54) PAPER CLIP

(71) Applicant: Scott G. Beach, Coral Springs, FL (US)

(72) Inventor: Scott G. Beach, Coral Springs, FL (US)

(21) Appl. No.: 13/852,551

(22) Filed: Mar. 28, 2013

Related U.S. Application Data
(60) Provisional application No. 61/728,245, filed on Nov. 20, 2012.

(51) Int. Cl. B42F 1/08

(52) U.S. Cl. CPC B42F 1/08
USPC 29/525.08; 24/67.9

(57) ABSTRACT

A paper clip for fastening two or more sheets of paper together, the paper clip formed of two substantially U-shaped clamping members, having elongate members formed in loops with a single loop facing in one direction and a pair of nesting loops facing in the opposite direction, the paper clip further including an elongate member, wherein a portion of the elongate member is bent to form a substantially C shape and another elongate member having a tip projecting at an angle into the open center of the C shape, the projecting tip for piercing through the papers at a common point for securely stapling the papers together, such that the papers are held together via the projecting tip in combination with the paper clip.

### CROSS-REFERENCE TO RELATED APPLICATIONS

This application claims the benefit of U.S. provisional application No. 61/728,248 filed Nov. 20, 2012, the disclosure of which is incorporated in its entirety herein by reference.

### BACKGROUND OF THE INVENTION

1. Field of the Invention

The present disclosure relates generally to a paper clip for securing at least two sheets of paper together. More particularly, the invention is directed to an improved paper clip wherein a portion of a member of the paper clip is bent to form a substantially C shape and wherein a tip of another member of the paper clip projects into an open portion in the center of the C shape for piercing through the papers at a common point, thereby securely stapling the papers together, such that the papers are held together via a combination of the projecting tip member and the paper clip.

2. Description of the Related Art

Paper clips known in the art include clips formed of elongate wire loops with a single loop facing in one direction and a pair of nesting loops facing in the opposite direction. These paper clips often slide off the papers they are holding together and become lost or entangled with other paper clips or other sheets of paper. Accordingly, paper clips have been developed that have wire loops with ridges for more securely holding sheets of paper together. However, paper clips with ridges are often difficult to remove and risk tearing the paper while being removed. Alternatively, people sometimes use staples rather than paper clips in order to secure sheets of paper with greater confidence. However, removing staples from attached sheets of papers can be complicated and usually requires the use of a staple remover.

It is desirable to have a paper clip for securely retaining papers together that is simple to remove and also grips the papers collectively at a common point, without slipping off or becoming entangled, while the papers are being handled or filed.

### SUMMARY OF THE INVENTION

In accordance with the present invention, a paper clip for retaining two or more sheets together includes two substantially U-shaped clamping members, such that a first clamping member is of a width greater than a second clamping member, so as to allow the second clamping member to be nested therein. The clip is substantially oblong and is composed of a single piece of wire. In a preferred embodiment, the wire is rounded. In an alternative embodiment, the paper clip may be formed of plastic or other resilient material. The sheets of paper to be clipped are inserted between the two U-shaped clamping members when the clamping members are sprung apart to allow for the placement of the papers. The second clamping member of the clip of the present invention includes two opposing relatively straight elongated members projecting upwards from either end of the bottom loop of the U-shape clamping members. The first clamping member of the clip of the present invention includes two opposing elongated members projecting upwards from the end of the bottom loop of the U-shape. The second clamping member is of a width less than the first clamping member, so as to enable the second clamping member to lie within the first clamping member in a nesting fashion. The improved paper clip provides that an elongated member of the first clamping member includes a relatively C shaped indentation positioned substantially in the upper half of the elongate member.

Additional modifications of the improved paper clip are provided such that an elongated member of the second clamping member of the paper clip includes a tip which projects at an angle and extends over the bottom segment of the C shaped indentation and into the cavity of the C shaped indentation formed by the C shape of the elongated member of the first clamping member for piercing the sheets of paper at a common point when the paper clip is in use. The positioning of an upper portion of the elongated member over the bottom segment of the C shaped indentation provides a stabilizing support for the projecting tip member and serves as a barrier to prevent the tip from tearing through the papers and causing injury when too much force is applied by a user to pierce the sheets of paper. In a preferred embodiment, the tip of the elongated member is inclined at a 90 degree angle relative to a planar surface of the paper clip. In another embodiment, the tip of the elongate member may be beveled. The tip may be angled at varying degrees and extend to varying lengths as may be readily understood in order to accommodate different ranges of sheets. The paper clip may be removed by lifting the projecting tip member from the clipped papers. Alternatively, the paper clip may be reapplied by inserting the papers between the two U-shaped clamping members when the clamping members are sprung apart to allow for the placement of the papers and positioning the tip over the previously punctured hole in the papers to avoid additional puncture points or marring of the papers. In this manner, the paper clip retains the sheets of paper via a combination of the projecting tip and the paper clip.

It is an object of the invention to provide a fastening means to secure two or more sheets of papers via a paper clip having a projecting tip that pierces through the sheets of paper at a common point.

It is another object of the invention to provide, a paper clip that will not slip or slide off of the sheets of paper, when the papers are being handled or filed.

It is yet another object of the invention to provide a combination paper clip with staple means for piercing through two or more sheets of paper at a common point, wherein the staple means and paper clip may be easily removed.

It is another object of the invention to provide a staple means for piercing through two or more sheets of paper, that can be reapplied at the same common point in order to avoid puncturing the papers at a different points, thereby avoiding unnecessary tearing or marring of the paper.

The summary of the present invention will become readily apparent upon further review of the following specifications and drawings.

### BRIEF DESCRIPTION OF THE DRAWINGS

FIG. 1 is a front view of the paper clip of the present invention.

FIG. 2 is a side perspective view of the paper clip of the present invention

FIG. 3 is a rear view of the paper clip of the present invention

FIG. 4 is a front view of the paper clip of the present invention while in use to fasten together two sheets of paper.

FIG. 5 is a side perspective view of the paper clip of the present invention while in use to fasten together two sheets of paper.

FIG. 6 is a perspective view of the projecting tip of the paper clip of the present invention piercing through two sheets of paper.

FIG. 7 is a rear view of the paper clip of the present invention while in use to fasten together two sheets of paper.

FIG. 8A is a perspective view of the paper clip of the present invention in use as the sheets of paper to be clipped are inserted between the two U-shaped clamping members when the clamping members are sprung apart to allow for the placement of the papers.

FIG. 8B is a perspective view of the paper clip of the present invention in use illustrating the elongate member with the projecting tip of the second clamping member as the projecting tip is lifted above the surface of the paper and the paper clip is slid over the papers.

FIG. 8C is a perspective view of the paper clip of the present invention illustrating the elongate member with the projecting tip of the second clamping member being placed in a position prior to the projecting tip puncturing the papers at a common point.

FIG. 8D is a perspective view of the paper clip of the present invention securing two sheets of paper together illustrating the projecting tip of the elongate member of the second clamping member piercing the papers at a common point

### DETAILED DESCRIPTION OF THE PREFERRED EMBODIMENTS

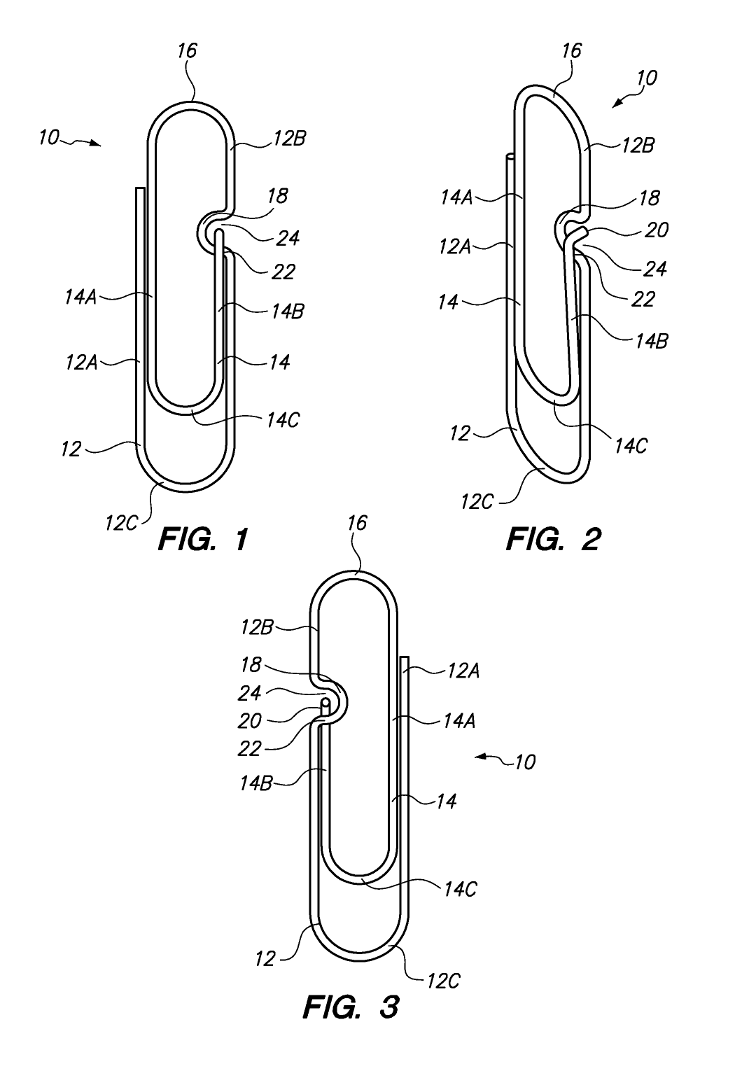

Referring now to FIGS. 1-8D, the paper clip 10 of the present invention is composed of a single piece of preferably round wire or other resilient material bent and coiled into the looped form seen in FIGS. 1-8D. The wire should possess a proper degree of spring or resiliency to cause portions of the clip to resume their relative positions when bent. The paper clip is substantially oblong in shape and includes two substantially U shaped clamping members, 12 and 14. The first clamping member 12 is of a width greater than the second clamping member 14, so as to enable the second clamping member 14 to lie within the first clamping member 12 in a nesting fashion.

The first clamping member 12 includes two substantially parallel and opposing elongate members 12A and 12B, whereby elongate members 12A and 12B are connected by a U-shaped bend, 12C. The second clamping member 14 includes two substantially parallel and opposing elongate members 14A and 14B, whereby elongate members 14A and 14B are connected by a U-shaped bend, 14C. An inverted U shaped bend 16 at the top of the paper clip 10 connects elongate member 12B of the first clamping member 12 with elongate member 14A of the second clamping member 14.

Elongate member 12B further includes a C-shaped indentation 18. In a preferred embodiment, the C-shaped indentation 18 is positioned in a region of the upper half of elongate member 12B. A top portion of elongate member 14B is bent at an angle to form a projecting tip or spur 20. The projecting tip 20 of elongate member 14B extends over a bottom segment 22 of the C-shaped indentation 18 and projects within a cavity 24 of the C-shaped indentation 18. The bottom segment 22 of the C-shaped indentation 18 of the elongate member 12B acts as a stabilizing support for elongate member 14B and serves as a barrier to prevent the projecting tip 20 from tearing through the papers 26 and causing injury to a user when too much force is applied on the projecting tip 20 when piercing the sheets of paper 26. In a preferred embodiment, the projecting tip 20 is beveled. The projecting tip 20 may extend to varying degrees or lengths as may be readily understood in order to accommodate different ranges of sheets of paper 26. In a preferred embodiment, the projecting tip 20 is inclined at a 90 degree angle, relative to a plane surface of the paper clip 10.

Thus, sheets of paper 26 are thereby inserted between the clamping members 12 and 14 which are sprung apart in the usual manner for this purpose and a moderate force is applied to elongate member 14B to cause the projecting tip 20 to pierce through the papers 26 at a common point 30, thereby causing the papers 26 to be secured via a combination clip and staple effect, resulting from the combined cooperative use of the clamping members 12 and 14 and the projecting tip 20.

Now particularly referring to FIG. 1, there is shown a front view of the paper clip 10 of the present invention.

Referring now to FIG. 2 there is shown a side perspective view of the paper clip 10 of the present invention

FIG. 3 is a rear view of the paper clip 10 of the present invention

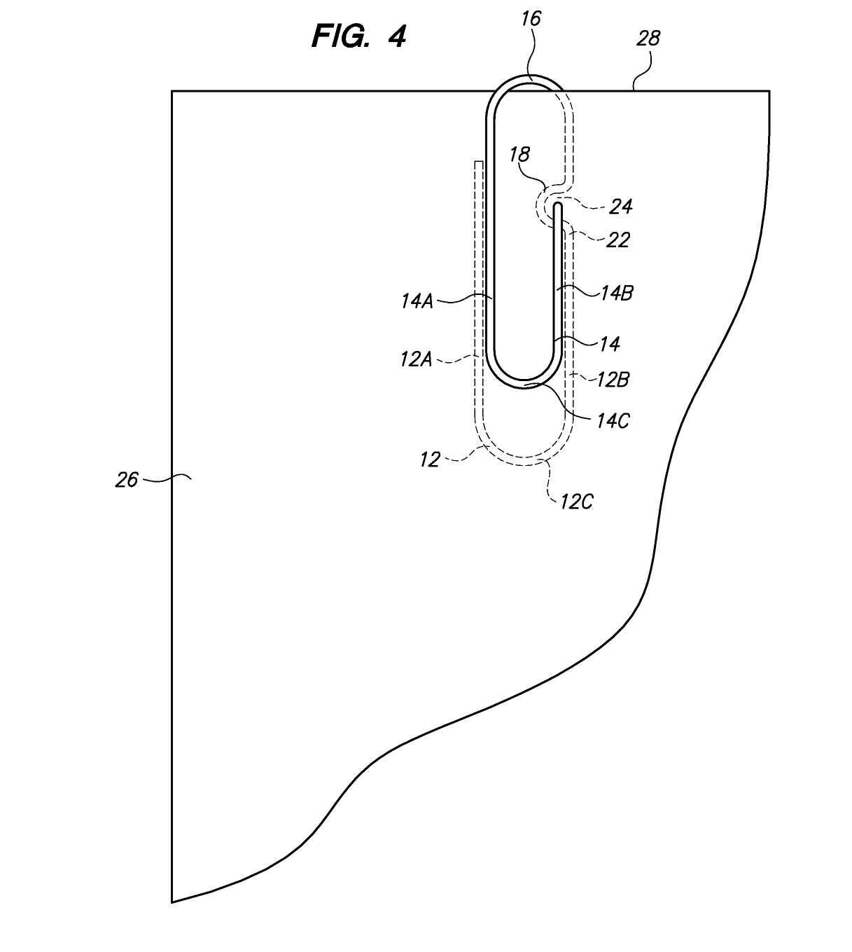

FIG. 4 is a front view of the paper clip 10 of the present invention while in use to fasten together two sheets of paper 26.

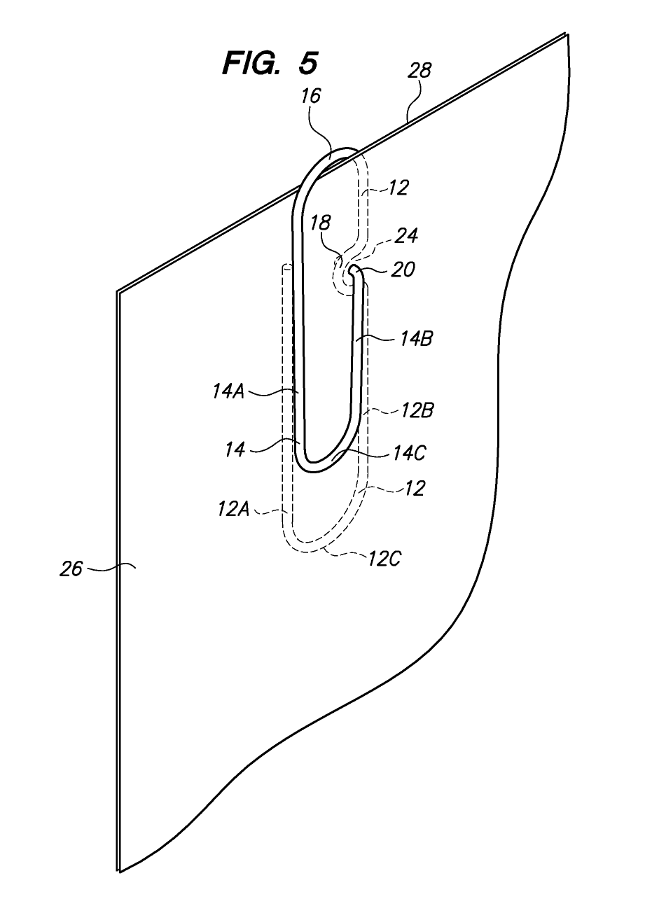

Now referring to FIG. 5 there is shown a side perspective view of the paper clip 10 of the present invention while in use to fasten together two sheets of paper 26.

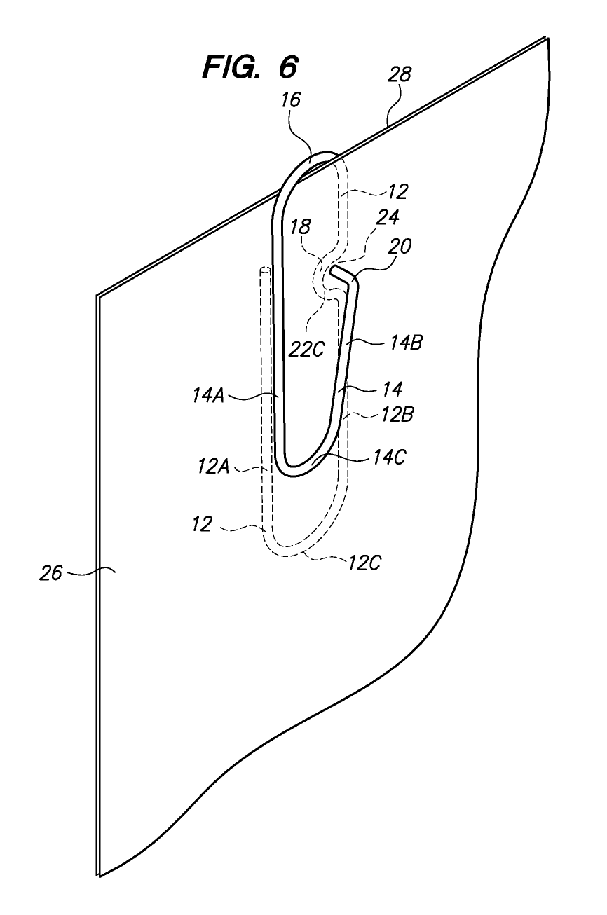

FIG. 6 is a perspective view of the projecting tip 20 of the paper clip 10 of the present invention piercing through two sheets of paper 26.

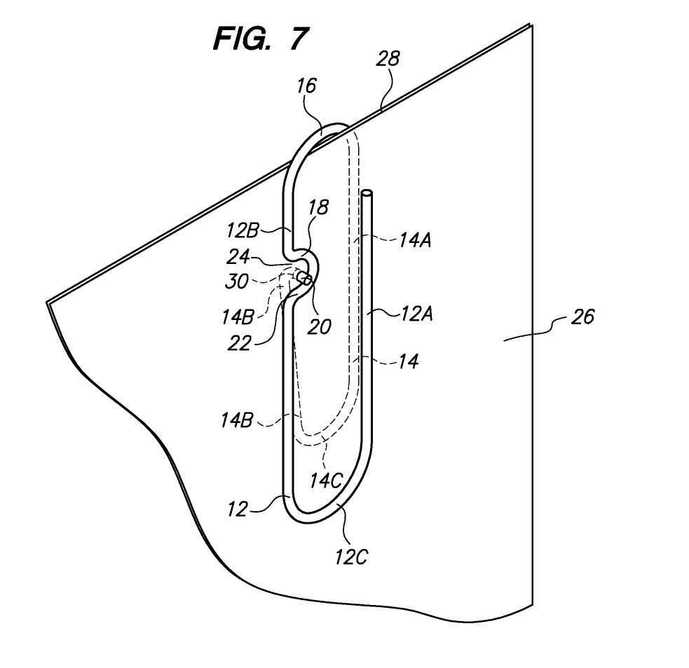

Referring to FIG. 7 is a rear view of the paper clip 10 of the present invention while in use to fasten together two sheets of paper 26.

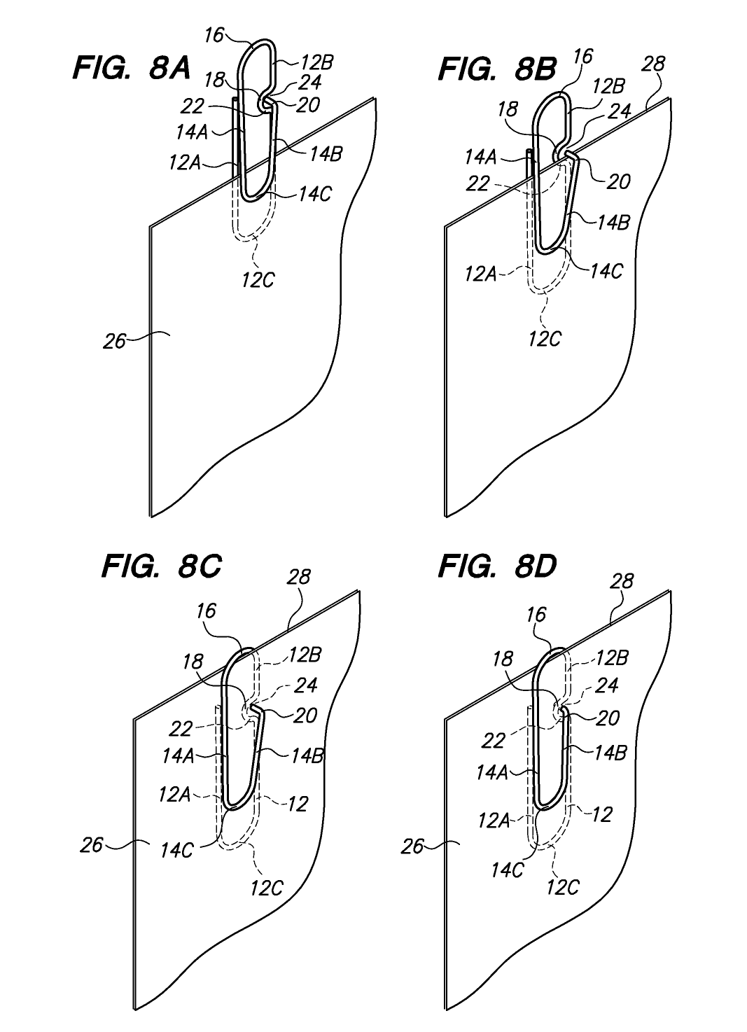

FIG. 8A is a perspective view of the paper clip 10 of the present invention in use as the sheets of paper 26 to be clipped are inserted between the two U-shaped clamping members 12, 14 when the clamping members 12, 14 are sprung apart to allow for the placement of the papers 26.

FIG. 8B is a perspective view of the paper clip 10 of the present invention in use illustrating the elongate member 14B with the projecting tip 20 of the second clamping member 14 as the projecting tip 20 is lifted above a surface edge 28 of the sheets of paper 26 and the paper clip 10 is slid over the papers 26.

FIG. 8C is a perspective view of the paper clip 10 of the present invention illustrating the elongate member 14B with the projecting tip 20 of the second clamping member 14 being placed in position prior to the projecting tip 20 puncturing the papers 26 at a common point 30.

FIG. 8D is a perspective view of the paper clip 10 of the present invention securing two sheets of paper 26 together illustrating the projecting tip 20 of the elongate member 14B of the second clamping member 14 piercing the papers 26 at a common point 30.

Thus, while there has been shown and described, fundamental novel features of the disclosure as applied to various specific embodiments thereof, it will be understood that various omissions and substitutions and changes in the form and details of the apparatus illustrated, and in their operation, may be made by those skilled in the art without departing from the spirit of the disclosure. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

I claim:

1. A paper clip for securing two or more sheets of paper, the paper clip comprising:
a single piece of resilient material bent and coiled into a substantially oblong shape, including two substantially U-shaped clamping members, the first clamping member having a width greater than a second clamping member, so as to enable the second clamping member to lie within the first clamping member in a nesting fashion;
the first clamping member having two substantially parallel and opposing first and second elongate members, whereby the first and second elongate members of the second clamping member are connected by a U-shaped bend, the second elongate member of the second clamping member further including a C-shaped indentation;
the second clamping member having two substantially parallel and opposing first and second elongate members, whereby the first and second elongate members of the second clamping member are connected by a U-shaped bend, and whereby a top portion of the second elongate member of the first clamping member extends over a bottom segment of the C-shaped indentation of the second elongate member of the second clamping member and bends at an angle to form a tip which projects into a cavity within the C-shaped indentation of the second elongate member of the second clamping member, whereby the projecting tip is for piercing the sheets of paper at a common point when the paper clip is in use; and
an inverted U-shaped bend at a top of the paper for connecting the first elongate member of the first clamping member with the second elongate member of the second clamping member.

2. The paper clip of claim 1, wherein the C-shaped indentation is positioned in a region of the upper half of the second elongate member of the first clamp member.

3. The paper clip of claim 1, wherein the single piece of material comprises a wire material.

4. The paper clip of claim 1, wherein the single piece of material comprises a plastic material.

5. The paper clip of claim 1, wherein the tip of the second elongate member of the first clamping member projects into the cavity of the C-shaped indentation at a 90 degree angle relative to a planar surface of the paper clip.

6. The paper clip of claim 1, wherein the tip of the second elongate member of the first clamping member is beveled.

7. A method of securing two or more sheets of papers together, the method comprising the steps of:
providing a the paper clip comprising a single piece of resilient material bent and coiled into a substantially oblong shape, including two substantially U-shaped clamping members, the first clamping member having a width greater than a second clamping member, so as to enable the second clamping member to lie within the first clamping member in a nesting fashion; the first clamping member having two substantially parallel and opposing first and second elongate members, whereby the first and second elongate members of the second clamping member are connected by a U-shaped bend, the second elongate member of the second clamping member further including a C-shaped indentation; the second clamping member having two substantially parallel and opposing first and second elongate members, whereby the first and second elongate members of the second clamping member are connected by a U-shaped bend, and whereby a top portion of the second elongate member of the first clamping member extends over a bottom segment of the C-shaped indentation of the second elongate member of the second clamping member and bends at an angle to form a tip which projects into a cavity within the C-shaped indentation of the second elongate member of the second clamping member, whereby the projecting tip is for piercing the sheets of paper at a common point when the paper clip is in use; and an inverted U-shaped bend at a top of the paper for connecting the first elongate member of the first clamping member with the second elongate member of the second clamping member;
inserting the sheets of paper between the first and second clamping members;
lifting the projecting tip of the top portion of the second elongate member of the first clamping member to allow for full insertion of the sheets of paper between the first and second clamping members of the paper clip; and
applying a moderate force to the projecting tip to pierce through the papers at a common point within the cavity of the C-shaped indentation of the second elongate member of the second clamping member, thereby causing the papers to be secured via a combination clip and staple effect.

8. The method of claim 7, wherein the bottom segment of the C-shaped indentation of the second elongate member of the second clamping member stabilizes the second elongate member of the first clamping member.
